(19) United States
(12) Patent Application Publication
(10) Pub. No.: US 2003/0194358 A1
(43) Pub. Date: Oct. 16, 2003

(54) Ozone generator

(76) Inventor: Bruce E. Minter, Eagle, ID (US)

Correspondence Address: Joseph W. Holland, P.O. Box 1840, Boise, ID, 83701-1840, US

(21) Appl. No.: 10/123,759

(22) Filed: Apr. 15, 2002

(51) Int. Cl. B01J 19/08

(52) U.S. Cl. 422/186.07; 422/186.18

(57) ABSTRACT

An ozone generator including a pair of electrodes separated by a dielectric element including a plurality of passages defining a corona discharge zone. In one embodiment of the invention, the passages may be convoluted in the sense that the lengths of the passages defining the corona discharge zone are greater than the length of the first and second electrodes and the dielectric element. This configuration provides for an extended period of exposure of the gas to the electric field and may result in production of ozone exhibiting improved stability and oxidation rate. In one embodiment, inner and outer concentric electrodes are held in spaced apart relationship by a concentric tubular dielectric. A corona discharge zone is defined between an inner surface of the outer tubular electrode and the outer surface of the concentric tubular dielectric by a plurality of passages formed on the outer surface of the concentric tubular dielectric.

### BACKGROUND

1. Field of Invention

This invention relates to ozone production for domestic and industrial applications, and more particularly, to an improved ozone generator and system.

2. Background of the Invention

Ozone gas (O₃) is a powerful oxidizing agent that has an oxidation potential about 1.5 times greater than that of chlorine. Ozone is used for various oxidation processes, water and air treatment and as a reactant in many chemical syntheses. Ozone is an unstable gas, which may be produced by exposing oxygen to an electric field derived from a high voltage alternating current. Ozone generators create an electric field by corona discharge between opposing electrodes with intervening dielectric. Corona discharge involves passing air between positively and negatively charged electrodes separated by a dielectric material and a discharge gap. In the process, the air in the highly-charged electric field between the electrodes becomes ionized and conductive such that oxygen in the air is converted to ozone.

Conventional ozone generators require substantial amounts of energy in order to produce a sufficient volume of ozone for commercially feasible use. For example, a conventional corona discharge ozone generator may require 100 kilowatt-hours of energy to produce 18 pounds of ozone in a 24-hour period. As a result, the cost of producing ozone can be a significant factor in considering the use of ozone as an oxidizing agent for any given process.

### SUMMARY OF THE INVENTION

The present invention is directed to an ozone generator including a pair of electrodes separated by a dielectric and at least one passage defining a corona discharge zone. The present invention is directed to an ozone generator used to generate ozone by flowing air, or other suitable gas including oxygen, through a corona discharge zone between a pair of charged elements or electrodes. In one embodiment of the invention, pressurized flowing air, or other suitable gas including oxygen, passes along a plurality of passages positioned between the one of the pair of charged elements or electrodes and the dielectric. The plurality of passages may be defined by a plurality of grooves formed on a surface of the dielectric element and a contacting surface of an electrode. In the alternative, the plurality of grooves may be formed in a surface of the electrode and the plurality of passages may be defined by the plurality of grooves formed on a surface of the electrode and a contacting surface of the dielectric element. In one embodiment of the invention, the grooves, and therefore the passages, are convoluted in the sense that the length of each passage is greater than the length of the dielectric material. As a result, a gas flowing along the plurality of passages must travel a distance greater than the length of the dielectric element in order to pass through the corona discharge zone. This configuration provides for an extended period of exposure of the gas to the electric field and may result in increased yields in the production of ozone, and the production of ozone exhibiting improved stability and oxidation rate.

In a preferred embodiment of the invention, inner and outer concentric tubular electrodes are held in spaced apart relationship by a concentric tubular dielectric. A corona discharge zone is defined between an inner surface of the outer tubular electrode and the outer surface of the concentric tubular dielectric by a plurality of passages formed on the outer surface of the concentric tubular dielectric.

### BRIEF DESCRIPTION OF THE DRAWINGS

FIG. 1 is a schematic representative view of an ozone generating system;

FIG. 2 is a representative perspective view of an ozone generator;

FIG. 3 is a representative side cutaway view of an ozone generator;

FIG. 4 is a representative partial cut-away side detail view of an ozone generator;

FIG. 5 representative partial cut-away side detail view of an ozone generator;

FIG. 6 is a representative cross-sectional view of an ozone generator taken substantially along lines 6-6 in FIG. 3;

FIG. 7A is representative side view of a dielectric element for an ozone generator;

FIG. 7B is representative side view of a dielectric element for an ozone generator; and

FIG. 8 is a representative perspective view of an alternate embodiment of an ozone generator according to the present invention.

### DETAILED DESCRIPTION

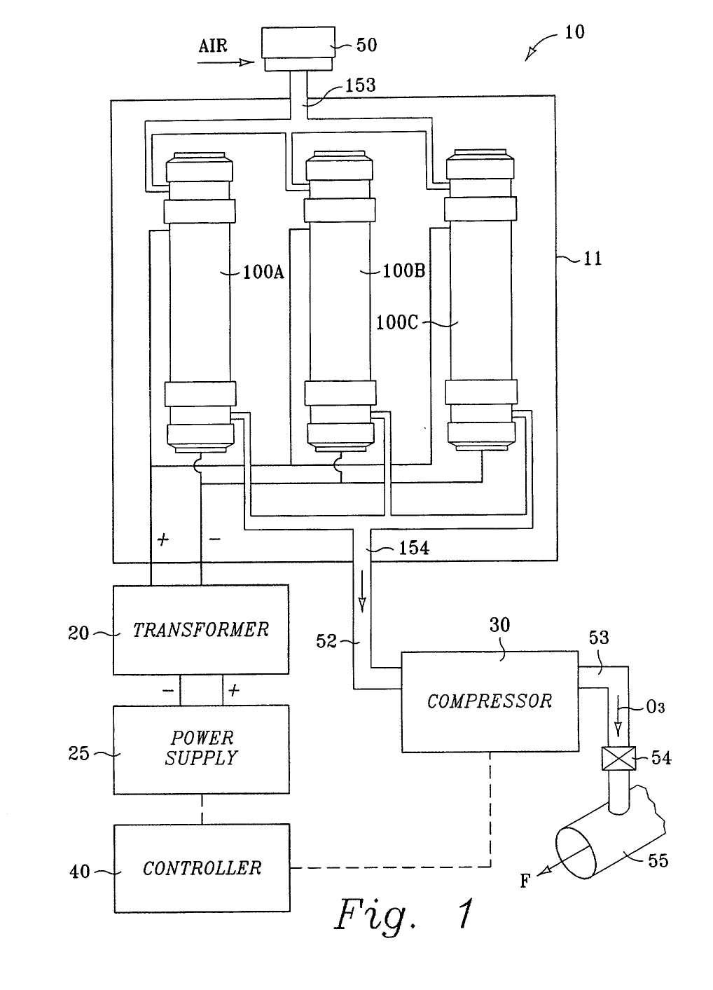

FIG. 1 is a representative perspective view of ozone generating system 10 including housing 11 which provides a protective enclosure for ozone generators 100A, 100B and 100C, each electrically coupled to transformer 20 which is electrically coupled to power supply 25. Ozone generating system 10 also includes controller 40 for controlling various functions and operations of ozone generating system 10. Ozone generating system 10 includes compressor 30 which is pneumatically connected to each of the ozone generators 100A, 100B and 100C for providing a flow of air through each of the ozone generators 100A, 100B and 100C. Compressor 30 is pneumatically connected to outlet 154 in such a manner that air is drawn through each of the ozone generators 100A, 100B and 100C under a vacuum. Compressor 30 is an oiless compressor and has a preferred rated output in the range of 20-80 psi, and preferably an output substantially equal to 75 psi. Inlet 153 includes check valve 50 which permits pneumatic communication with each of the ozone generators 100A, 100B and 100C in an inflow direction only. Outlet 154 is pneumatically connected to outlet compressor inlet 52. Compressor outlet 53 may be fluidly connected to a fluid stream flow F contained within pipe 55 for direct treatment of the fluid with ozone. Alternatively, compressor outlet 53 may be fluidly connected to a vessel for storage or treatment, not shown. Control valve 54 prohibits a fluid flow from pipe 55 upstream to compressor 30. Alternatively, an inline check valve may be used to prevent backflow to compressor 30.

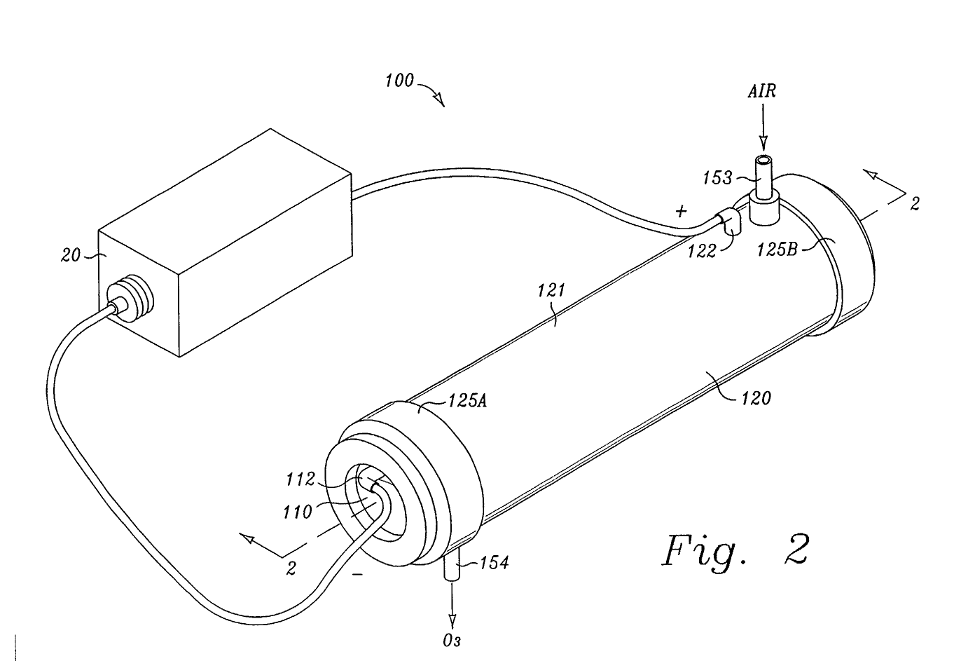

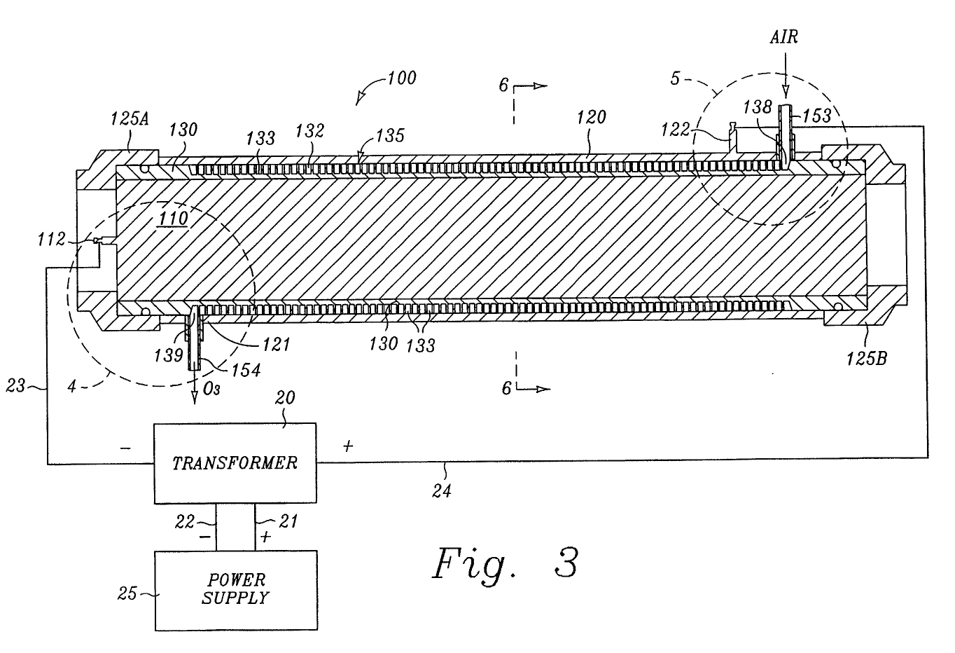

FIGS. 2 and 3 show ozone generator 100 electrically coupled to transformer 20. Ozone generator 100 includes first terminal 112 conductively connected to first electrode 110 and second terminal 122 conductively connected to second electrode 120. Inlet 153 pneumatically communicates through wall 121 of second electrode 120 with inlet plenum 138, shown in FIG. 3, and outlet 154 pneumatically communicates through wall 121 with outlet plenum 139, shown in FIG. 3. End caps 125A and 125B provide protection against impact and are configured to provide a pneumatic seal as shown in FIG. 3.

Referring to FIG. 3, ozone generator 100 is shown including first electrode 110 and second electrode 120 held in spaced apart relationship by dielectric element 130. Dielectric element 130 is configured as shown to include a plurality of grooves 133, which together with the fit between an outer surface of dielectric element 130 and an inner surface of second electrode 120, form a plurality of passages 132 which collectively form corona discharge zone 135. The fit between second electrode 120 and dielectric element 130 is preferably such that each of the resulting plurality of passages 132 are substantially pneumatically isolated from adjoining passages. This configuration results in a structure including a plurality of passages 132 through which a gas can flow between first electrode110 and second electrode 120 without migrating laterally between passages.

In the embodiment of ozone generator 100 shown in FIG. 3, inner electrode 110, dielectric element 130, and second electrode 120 are all at least generally cylindrical in shape. First electrode110 is shown formed as a solid cylindrical billet, although other configurations including tubular configurations are possible. First electrode110 fits coaxially within dielectric element 130, and second electrode 120 fits coaxially around dielectric element 130. Preferably, the fit between first electrode110 and dielectric element 130 is a clearance fit in the range of 0.005 inches to 0.010 inches and more preferably substantially equal to 0.007 inches. First electrode110 In other embodiments, other shapes are possible for first electrode110, dielectric element 130, and second electrode 120 without departing from the basic function of the ozone generator 100. For example, these elements can all have at least generally rectangular cross-sections, ovoid cross-sections, or other configurations that produce ozone in substantially the same way as ozone generator 100.

In one embodiment of the invention, dielectric element 130 comprises a dielectric material having a minimum dielectric loss of 450 amps per million. In another embodiment of the invention, dielectric element 130 comprises a dielectric material having a dielectric loss in the range of 450-1000 amps per million.

In one embodiment of the invention, dielectric element 130 comprises a dielectric material having a minimum dielectric strength of 375 V/mil. In another embodiment of the invention, dielectric element 130 comprises a dielectric material having a dielectric strength in the range of 375-1000 V/mil. In another embodiment of the invention, dielectric element 130 comprises a dielectric material having a dielectric strength substantially equal to 450 V/mil. Dielectric strength is defined as the maximum voltage a material can withstand without conducting electricity through the thickness of the material expressed in volts per mil thickness of material. In addition, dielectric element 130 preferably comprises a dielectric material having a maximum operating temperature equal to or greater than 275° F. In addition, dielectric element 130 preferably comprises a dielectric material having a specific gravity equal to or greater than 1.20 g/cm³.

In one embodiment of the invention, dielectric element 130 comprises a material identified as Polysulfone manufactured by Saint Gobain Performance Plastics. Preferably, a cylindrical tubular segment formed of Polysulfone material is machined to form dielectric element 130. Following machining, dielectric element 130 is heat treated by soaking at a temperature in the range of 300-400 degrees Fahrenheit, and more preferably at a temperature substantially equal to 392 degrees Fahrenheit, for a period of one hour.

In other embodiments of the invention, dielectric element 130 comprises a material selected from a group of materials including polysulfone such as Udel®, a polyyetherimide such as Ultem®, a Polyethersulfone/Polyarylsulfone such as Radel® and a Polyetherether Ketone, PEEK. Another suitable material that can be used for dielectric element 130 is a dielectric ceramic material.

In one embodiment, first electrode 110 may be formed of a material having a different electrical conductivity than second electrode 120. In another embodiment of the invention, first electrode110 may be formed of a material having a relatively lower conductivity than second electrode 120. For example, first electrode110 may comprise an aluminum alloy and second electrode 120 may comprise a stainless steel alloy having a relatively lower conductivity than the aluminum alloy. In one embodiment, first electrode110 is comprised of an aluminum alloy billet. In other embodiments, first electrode110 is configured as a tubular segment and includes a wall thickness of 0.50 inch. Other materials having other wall thicknesses can be used for first electrode110. Second electrode 120 may have a wall thickness substantially equal to 0.25 inch where second electrode 120 is comprised of a stainless steel alloy. In other embodiments, other materials having other wall thicknesses can be used for second electrode 120.

As shown in FIG. 3, ozone generator 100 is electrically connected to transformer 20 which applies a high voltage current between first electrode110 and second electrode 120. In one embodiment, transformer 20 is a conventional step-up transformer of 120 volts AC at 890 volt-amps primary, and 15,000 volts AC at 60 milliamps secondary. In other embodiments, other transformers may be used. Transformer 20 has a primary positive lead 21, primary negative lead 22, secondary negative lead 23, and secondary positive lead 24. Primary positive lead 21 and primary negative lead 22 are conductively connected to power supply 25. Secondary negative lead 23 is connected to first electrode110 at first terminal 112, and secondary positive lead 24 is connected to second electrode 120 at second terminal 122.

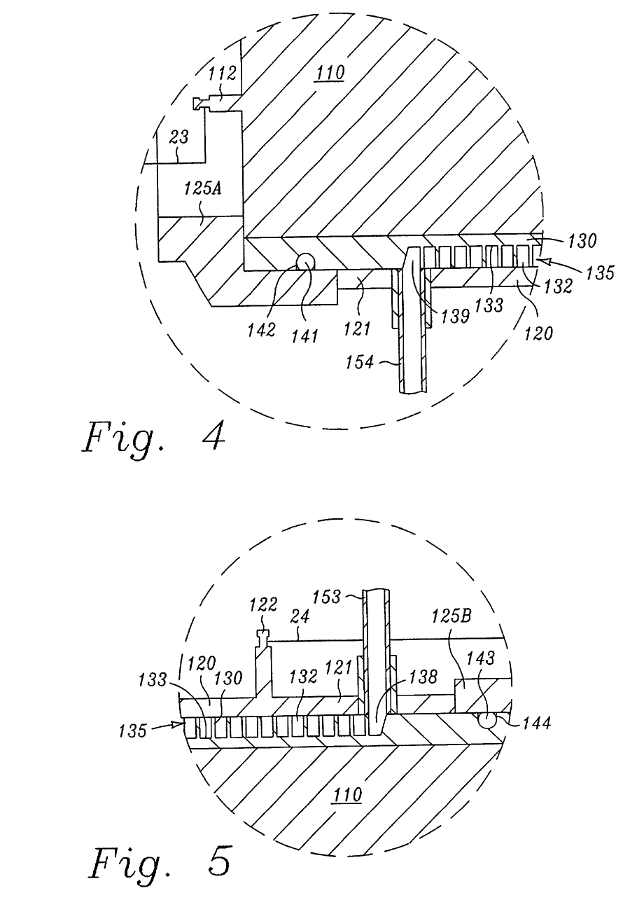

FIGS. 4 and 5 are representational cutaway details showing first electrode 110, second electrode 120 and dielectric element 130. Dielectric element 130 includes a plurality of grooves 133 which, together with the fit between an outer surface of dielectric element 130 and an inner surface of second electrode 120, form a plurality of passages 132 which collectively form corona discharge zone 135.

Referring to FIG. 4, outlet 154 pneumatically communicates with outlet plenum 139 through wall 121 of second electrode 120 for expelling a flow of gas including ozone. FIG. 4 also shows to advantage secondary negative lead 23 conductively connected to first terminal 112 which is conductively connected to first electrode110.

As seen in FIG. 5, inlet 153 pneumatically communicates with inlet plenum 138 through wall 121 of second electrode 120. Inlet plenum 138 is fluidly connected to outlet plenum 139 and a flow of gas, such as air, passes along plurality of passages 132 from inlet plenum 138 to the outlet plenum 139, as seen in FIG. 3. Gas passing through plurality of passages 132 is exposed to an electrical field in corona discharge zone 135. FIG. 5 also shows to advantage secondary positive lead 24 conductively connected to second terminal 122 which is conductively connected to second electrode120.

Inlet plenum 138, outlet plenum 139 and corona discharge zone 135 are pneumatically isolated between dielectric element 130 and second electrode 120 as follows. As shown in FIG. 4, o-ring 141 is disposed in groove 142 and provides a substantially air-tight seal between dielectric element 130 and end cap 125A. As shown in FIG. 5, o-ring 143 is disposed in groove 144 and provides a substantially air-tight seal between the dielectric element 130 and end cap 125B.

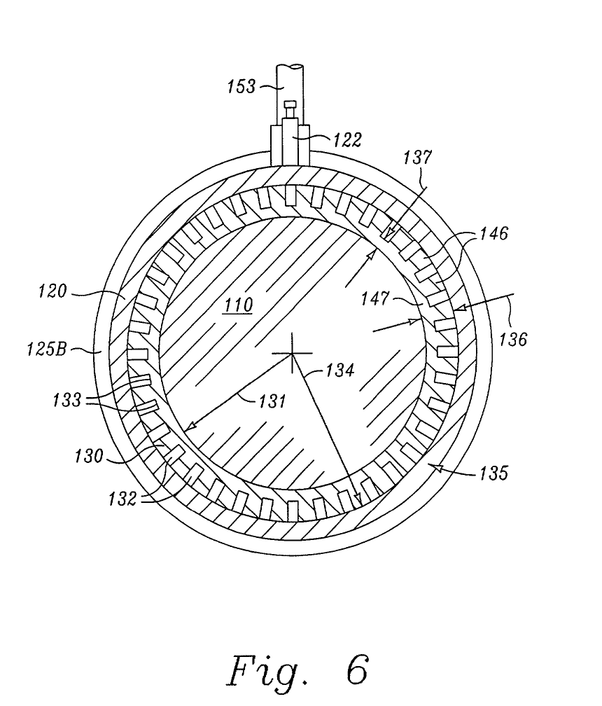

FIG. 6 is a cross-sectional view of dielectric element 130 taken substantially along lines 6-6 in FIG. 3 in accordance with a preferred embodiment of the invention. Dielectric element 130 has an inner surface radius 131, an outer surface radius 134, and a resulting nominal wall thickness 136.

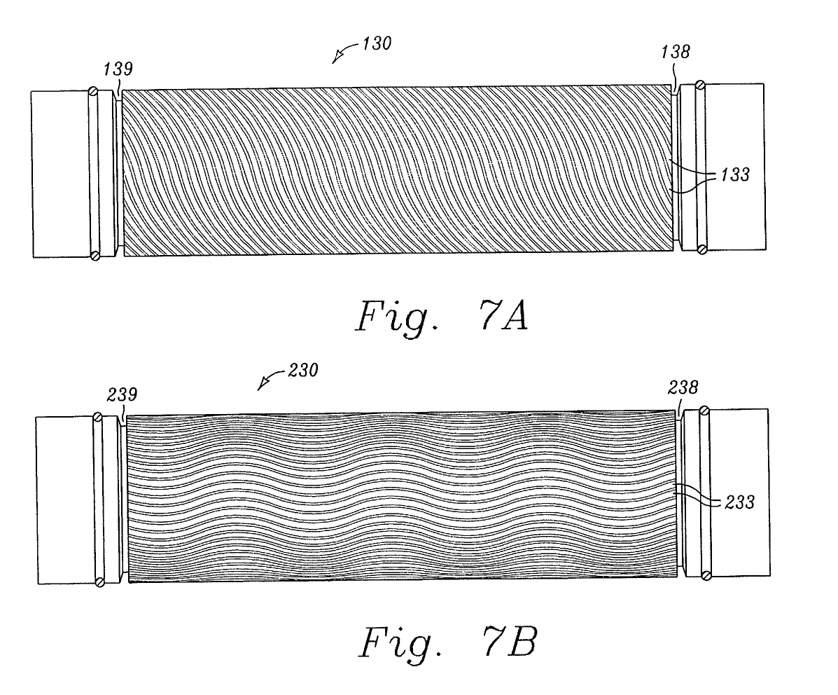

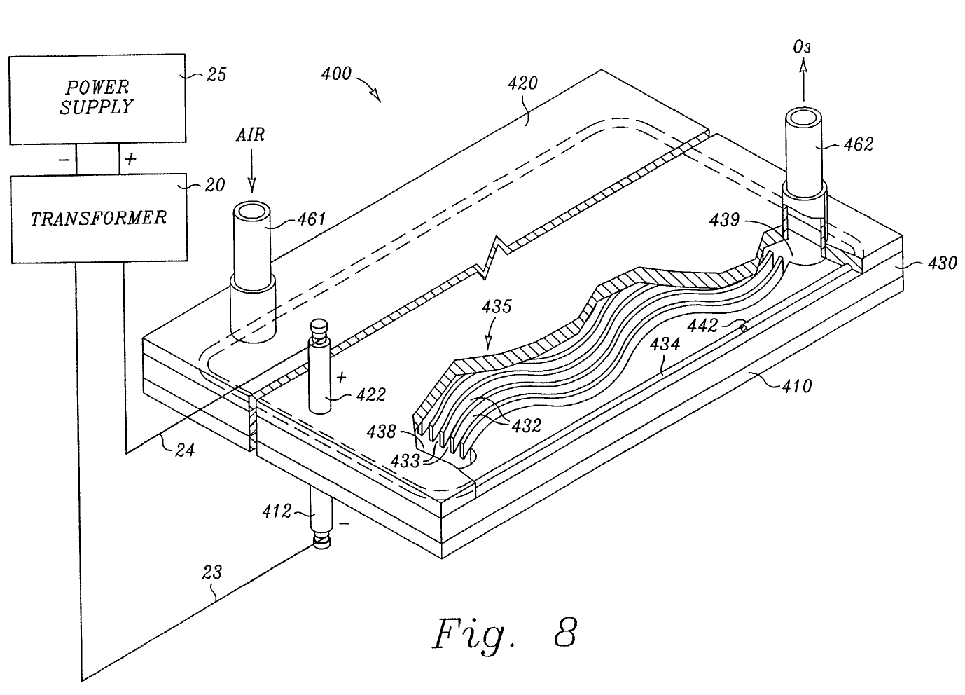

FIG. 7A is a side elevation of dielectric element 130 in accordance with a preferred embodiment of the invention. The plurality of grooves 133 are formed on an outer surface of dielectric element 130 and are uniformly spaced apart from each other, extending along spiral paths around dielectric element 130. The plurality of grooves 133 extend from inlet plenum 138 at one end and outlet plenum 139 at the other end. The spiral paths of the plurality of grooves 133 increases the time period that the gas resides between first electrode110 and second electrode 120 compared to a plurality of straight passages which lie parallel to a longitudinal axis of the dielectric element. In other embodiments, the plurality of grooves 133 can be non-uniformly spaced apart from each other and/or extend along other paths from inlet plenum 138 to the outlet plenum 139.

FIG. 7B is a side elevation view of a dielectric element 230 in accordance with an alternate embodiment of the invention. In this embodiment, the dielectric element 230 has a plurality of serpentine grooves 233 that are uniformly spaced apart from one another and extend from the inlet plenum 238 to the outlet plenum 239. Channel paths extending along spiral or serpentine paths over the outer surface of the dielectric element are but two examples of circuitous paths that could be used to achieve an extended exposure period.

As best seen in FIG. 1, ozone can be generated using the ozone generator 100 by flowing a gas comprising oxygen at a selected pressure from the inlet 153 through the plurality of passages 132 toward the outlet 154, while selected electric potentials are maintained on first electrode110 and second electrode 120. In one embodiment, ozone is generated by introducing air through inlet 153 into inlet plenum 138. In other embodiments, ozone can be generated by using air and other gases comprising oxygen at other pressures. Once the air enters the inlet plenum 138, it travels through plurality of passages 132 collectively forming corona discharge zone 135 between the charged inner and second electrodes 110 and 120.

In one embodiment of the invention, second electrode 120 comprises a 0.50 inch thick aluminum alloy, first electrode110 comprises a 0.25 inch thick stainless steel alloy and dielectric element 130 includes a tubular dielectric material formed of polysulfone. Referring to FIG. 6, the polysulfone dielectric element 130 includes an inner surface radius 131 of 1.75 inches, an outer surface radius 134 of 2.25 inches and a nominal wall thickness 136 substantially equal to 0.50 inch. In other embodiments, the nominal wall thickness 136 can be different than 0.50 inch. The plurality of grooves 133 may each include a generally U-shaped cross-section defined by adjacent upright wall segments 146 and adjoining root wall segment 147. In one embodiment of the invention, root wall segment 137 includes a root wall thickness 137 in the range of 0.030-0.080 inch, and preferably substantially equal to 0.063 inch. In one embodiment of the invention, the thickness of each upright wall segment 146 is approximately 0.030-0.080 inch, and preferably substantially equal to the thickness of the root wall segment 137, or in this instance 0.063 inch. The thickness of the root wall segment 137 and upright wall segments 146 can be more or less than 0.063 inch based upon the strength of the electric field, the type of dielectric material, and other factors. The negative electric potential may be in the range of approximately −5,000 to −20,000 volts and the positive electrical potential is approximately 5,000 to 20,000 volts. More preferably, the negative electric potential is approximately −15,000 volts and the positive electric potential is approximately 15,000 volts. In other embodiments, the electric potentials applied to the first and second electrodes 110 and 120 can be more or less than these potentials. As the air flows through the plurality of passages 132 in corona discharge zone 135, at least some of the oxygen in the air is converted to ozone by the time that the flow reaches outlet 154.

FIG. 8 is a partial cutaway isometric view of a planar ozone generator 400 in accordance with an alternate embodiment of the invention. Ozone generator 400 has a generally planar first electrode 410, a generally planar second electrode 420, and a generally planar dielectric element 430 sandwiched between the first and second electrodes 410 and 420, respectively. A plurality of grooves 433 are formed in the dielectric element 430 and span between an inlet plenum 438 and an outlet plenum 439. Inlet 461 is attached to second electrode 420 and fluidly communicates with inlet plenum 438. Similarly, outlet 462 is attached to second electrode 420 and fluidly communicates with outlet plenum 439. Inlet plenum 438 fluidly communicates with outlet plenum 439 via the plurality of passages 432. Air, or other gas including oxygen, is introduced through inlet 461 into inlet plenum 438. Rectangular seal 442 is positioned in groove 434 in dielectric element 430 creating a substantially air-tight seal between the dielectric element 430 and second electrode 420 that surrounds the plurality of grooves 433, inlet plenum 438 and outlet plenum 439.

First terminal 412 is conductively connected to first electrode 410 and second terminal 422 is conductively connected to second electrode 420. Ozone generator 400 may be electrically connected to transformer 20 which applies a high voltage current between first electrode 410 and second electrode 420. Secondary negative lead 23 is connected to the second terminal 122, and secondary positive lead 24 is connected to first terminal 412.

Ozone can be generated with the ozone generator 400 in a manner substantially similar to the method employed with ozone generator 100. Air or another gas with oxygen is introduced at a selected pressure through inlet 461 into inlet plenum 438 passing along the plurality of passages 432 toward the outlet plenum 439. The gas passes through corona discharge zone 435 defined between first electrode 410 and second electrode 420 and more particularly between inlet plenum 438 and outlet plenum 439 and the plurality of grooves 433 formed on the upper surface of dielectric element 430, and more particularly in a plurality of passages 432 formed as a result of the fit between the plurality of grooves 433 formed on the upper surface of dielectric element 430 and the lower or inner contacting surface of second electrode 420. Generated ozone is expelled from outlet 462 to a storage or distribution device, (not shown).

Like the generally cylindrical ozone generator 100 shown in FIGS. 1 through 6, the generally planar ozone generator 400 may be capable of producing ozone more efficiently than conventional corona discharge ozone generators. In addition, because the basic elements of the planar ozone generator 400 are generally planar in shape, they may be easier to manufacture than the functionally similar, but cylindrically configured, elements of the ozone generator 100. The planar ozone generator 400 may also be easier to assemble than the cylindrical ozone generator 100, which requires assembly of coaxially disposed cylindrical elements.

From the foregoing, it will be appreciated by those of skill in the art that even though specific embodiments of the invention have been described herein for purposes of illustration, various modifications can be made without departing from the spirit or scope of the present invention. In general, the terms in the claims should not be construed to limit the invention to the specific embodiments disclosed in the foregoing description, but should be construed to include all ozone generating systems and ozone generators that operate in accordance with the claims.

I claim:

1. An ozone generator comprising:
a first electrode;
a second electrode held in spaced apart relationship from the first electrode; and
a dielectric element positioned between the first electrode and the second electrode;
a passage formed between the second electrode and the dielectric element, the passage defining a corona discharge zone;
an inlet pneumatically connected to the passage for allowing an inflow of a gas including oxygen to the passage; and
an outlet pneumatically connected to the passage for allowing an outflow of ozone from the passage.

2. The ozone generator of claim 1 wherein the first electrode further comprises a material having a relatively higher electrical conductivity than a material comprising the second electrode.

3. The ozone generator of claim 1 further comprising:
the first electrode comprising an aluminum alloy; and
the second electrode comprising a stainless steel alloy.

4. The ozone generator of claim 1 wherein the dielectric element further comprises a dielectric material having a minimum dielectric strength of 375 V/mil.

5. The ozone generator of claim 1 wherein the dielectric element further comprises a dielectric material having a minimum dielectric strength in the range of 375-1000 V/mil.

6. The ozone generator of claim 1 wherein the dielectric element further comprises a dielectric material selected from a group of dielectric materials including a polysulfone, a polyyetherimide, a polyethersulfone/polyarylsulfone such as and a polyetherether ketone.

7. The ozone generator of claim 1 wherein the dielectric element further comprises a dielectric material including a plurality of grooves formed on a surface of the dielectric element, a plurality of passages defined by the plurality of grooves and a contacting surface of the first electrode.

8. The ozone generator of claim 1 wherein the dielectric element further comprises a plurality of convoluted grooves formed on a surface of the dielectric element, a plurality of passages defined by the plurality of grooves and a contacting surface of the second electrode.

9. The ozone generator of claim 1 wherein the dielectric element further comprises a plurality of convoluted grooves formed on a surface of the dielectric element, a plurality of passages defined by the plurality of grooves and a contacting surface of the second electrode.

10. The ozone generator of claim 1 further comprising an electrical power supply electrically coupled to the first electrode and the second electrode generating an electrical field in the corona discharge zone.

11. The ozone generator of claim 1 further comprising an electrical power supply including a negative terminal electrically coupled to the first electrode and a positive terminal electrically coupled to the second electrode generating an electrical field in the corona discharge zone.

12. The ozone generator of claim 1 further comprising an electrical power supply including an electric potential output of at least approximately 7500 volts.

13. The ozone generator of claim 1 further comprising an electrical power supply including an electric potential output in the range of 5,000 to 20,000 volts.

14. An ozone generator comprising:
a first cylindrical electrode;
a second cylindrical electrode coaxially disposed about an exterior of the first cylindrical electrode; and
a cylindrical dielectric element coaxially disposed between the first cylindrical electrode and the second cylindrical electrode, the cylindrical dielectric element including a passage defining a corona discharge zone.

15. The ozone generator of claim 14 wherein the first electrode further comprises a material having a relatively higher electrical conductivity than a material comprising the second electrode.

16. The ozone generator of claim 14 further comprising:
the first cylindrical electrode comprising an aluminum alloy; and
the second cylindrical electrode comprising a stainless steel alloy.

17. The ozone generator of claim 14 wherein the cylindrical dielectric element further comprises a dielectric material having a minimum dielectric loss of 450 amps per million.

18. The ozone generator of claim 14 wherein the cylindrical dielectric element further comprises a dielectric material having a minimum dielectric strength in the range of 375-1000 V/mil.

19. The ozone generator of claim 14 wherein the cylindrical dielectric element further comprises a dielectric material selected from a group of dielectric materials including a polysulfone such as Udel®, a polyyetherimide such as Ultem®, a Polyethersulfone/Polyarylsulfone such as Radel® and a Polyetherether Ketone, PEEK.

20. The ozone generator of claim 14 wherein the cylindrical dielectric element further comprises a dielectric material including a plurality of grooves formed on a surface of the dielectric element, a plurality of passages defined by the plurality of grooves and a contacting surface of the first electrode.

21. The ozone generator of claim 14 wherein the cylindrical dielectric element further comprises a plurality of convoluted grooves formed on a surface of the dielectric element, a plurality of passages defined by the plurality of grooves and a contacting surface of the second electrode.

22. The ozone generator of claim 14 wherein the cylindrical dielectric element further comprises a plurality of convoluted grooves formed on a surface of the dielectric element, a plurality of passages defined by the plurality of grooves and a contacting surface of the second electrode.

23. The ozone generator of claim 14 further comprising an electrical power supply electrically coupled to the first electrode and the second electrode generating an electrical field in the corona discharge zone.

24. The ozone generator of claim 14 further comprising an electrical power supply including a negative terminal electrically coupled to the first electrode and a positive terminal electrically coupled to the second electrode generating an electrical field in the corona discharge zone.

25. The ozone generator of claim 14 further comprising an electrical power supply including an electric potential output of at lea st approximately 7500 volts.

26. The ozone generator of claim 14 further comprising an electrical power supply including an electric potential output in the range of 5,000 to 20,000 volts.

27. The ozone generator of claim 14 wherein:
the first cylindrical electrode comprises stainless steel having a nominal wall thickness of approximately 0.10-0.38 inch;
the second cylindrical electrode comprises aluminum having a nominal wall thickness of approximately 0.25-0.50 inch; and
the cylindrical dielectric element comprises a dielectric material having a nominal wall thickness of approximately 0.25-0.75 inch.

28. The ozone generator of claim 14 wherein the cylindrical dielectric element further comprises a plurality of grooves formed on an outer surface of the dielectric element, the plurality of grooves defined by a pair of substantially upright wall segments and a connecting root wall segment, each substantially upright wall segment having a wall thickness substantially equal to approximately 0.040-0.080 inch and the connecting root wall segment having a wall thickness substantially equal to approximately 0.040-0.080 inch.

29. The ozone generator of claim 14 wherein the cylindrical dielectric element further comprises a plurality of grooves formed on an outer surface of the dielectric element, the plurality of grooves defined by a pair of substantially upright wall segments and a connecting root wall segment, wherein each of the plurality of grooves extends along a spiral path around the outer surface of the dielectric element.

30. An ozone generating system comprising:
a first electrode;
a second electrode held is spaced apart relationship from the first electrode; and
a dielectric element positioned between the first electrode and the second electrode;
a passage formed between the second electrode and the dielectric element, the passage defining a corona discharge zone;
an inlet pneumatically connected to the passage for allowing an inflow of a gas including oxygen to the passage; and
an outlet pneumatically connected to the passage for allowing an outflow of ozone from the passage; and
an electrical power supply electrically coupled to the first electrode and the second electrode to generate an electrical field in the corona discharge zone.

31. The ozone generating system of claim 30 further comprising a compressor connected to the outlet for drawing a gas including oxygen through the inlet and through the passage.

32. The ozone generator of claim 30 wherein the first electrode further comprises a material having a relatively higher electrical conductivity than a material comprising the second electrode.

33. The ozone generator of claim 30 further comprising:
the first electrode comprising an aluminum alloy; and
the second electrode comprising a stainless steel alloy.

34. The ozone generator of claim 30 wherein the dielectric element further comprises a dielectric material having a minimum dielectric loss of 450 amps per million.

35. The ozone generator of claim 30 wherein the dielectric element further comprises a dielectric material having a minimum dielectric strength in the range of 375-1000 V/mil.

36. The ozone generator of claim 30 wherein the dielectric element further comprises a dielectric material selected from a group of dielectric materials including a polysulfone, a polyyetherimide, a polyethersulfone/polyarylsulfone and a polyetherether ketone.

37. The ozone generator of claim 30 wherein the dielectric element further comprises a dielectric material including a plurality of grooves formed on a surface of the dielectric element, a plurality of passages defined by the plurality of grooves and a contacting surface of the first electrode.

38. The ozone generator of claim 30 wherein the dielectric element further comprises a plurality of convoluted grooves formed on a surface of the dielectric element, a plurality of passages defined by the plurality of grooves and a contacting surface of the second electrode.

39. The ozone generator of claim 30 wherein the dielectric element further comprises a plurality of convoluted grooves formed on a surface of the dielectric element, a plurality of passages defined by the plurality of grooves and a contacting surface of the second electrode.

40. The ozone generator of claim 30 further comprising an electrical power supply electrically coupled to the first electrode and the second electrode generating an electrical field in the corona discharge zone.

41. The ozone generator of claim 30 further comprising an electrical power supply including a negative terminal electrically coupled to the first electrode and a positive terminal electrically coupled to the second electrode generating an electrical field in the corona discharge zone.

42. The ozone generator of claim 30 further comprising an electrical power supply including an electric potential output of at least approximately 7500 volts.

43. The ozone generator of claim 30 further comprising an electrical power supply including an electric potential output in the range of 5,000 to 20,000 volts.

44. The ozone generator of claim 30 wherein:
the first electrode comprises aluminum having a diameter substantially equal to 1.75 inches;
the second electrode comprises stainless steel having a nominal wall thickness of approximately 0.10-0.38 inch; and
the dielectric element comprises a dielectric material having a nominal wall thickness of approximately 0.25-0.75 inch.

45. The ozone generator of claim 30 wherein the dielectric element further comprises a plurality of grooves formed on an outer surface of the dielectric element, the plurality of grooves defined by a pair of substantially upright wall segments and a connecting root wall segment, each substantially upright wall segment having a wall thickness substantially equal to approximately 0.040-0.080 inch and the connecting root wall segment having a wall thickness substantially equal to approximately 0.040-0.080 inch.

46. The ozone generator of claim 30 wherein the dielectric element further comprises a plurality of grooves formed on an outer surface of the dielectric element, the plurality of grooves defined by a pair of substantially upright wall segments and a connecting root wall segment, wherein each of the plurality of grooves extends along a spiral path around the outer surface of the dielectric element.
